(19) United States
(12) Patent Application Publication
(10) Pub. No.: US 2010/0100955 A1
(43) Pub. Date: Apr. 22, 2010

(54) SYSTEM AND METHOD FOR SECURE OS ACCESS IN AN ECMA-SCRIPT VIRTUAL MACHINE

(75) Inventors: Mark Young, San Jose, CA (US); Arvin Haywood, Mountain View, CA (US)

Correspondence Address: RG & ASSOCIATES, 1103 TWIN CREEKS, STE. 120, ALLEN, TX, 75013, US

(73) Assignee: NUMOBIQ INC., Fremont, CA (US)

(21) Appl. No.: 12/252,562

(22) Filed: Oct. 16, 2008

(51) Int. Cl. G06F 13/00

(52) U.S. Cl. 726/17

(57) ABSTRACT

In an ECMAScript (JavaScript) Virtual Machine, applications are isolated from the operating system by defining an application context for each application. A root application context is defined that binds scripted objects of the root application context to equivalent native objects of the virtual machine. Other application contexts may send events on an event bus via the root application context to request resources of the operating system. The root application context determines the security privileges of the application context with respect to the requested resource, and is the only application context that is able to interact with the operating system.

### FIELD OF THE INVENTION

This disclosure relates to providing secure access to resources of an operating system for application code running on a virtual machine.

### BACKGROUND OF THE INVENTION

Traditionally, ECMAScript (commonly referred to as JavaScript) Virtual Machines either do not allow native system access from scripted code (in the case of web browsers), or they do so via some direct language binding between the script context and the native code (a bridge from script to C/C++). In the former there is no access at all, thus security is absolute. In the latter, either the native bridge enforces some security policy directly or it does not enforce security at all.

What is required is a system, method and computer readable medium that allows native system access while providing a high level of security.

### SUMMARY OF THE INVENTION

In one embodiment of the disclosure, there is provided a method for providing an interaction between an application executing in a virtual machine and an operating system. The method comprises defining an application context for the application, receiving an operating system resource request from the application context, providing the operating system resource request to a root application context defined in the virtual machine, determining in the root application context whether the requesting application has operating system privileges for a requested resource, and providing the operating system resource request to the operating system dependent on the operating system privileges determined for the operating system resource request.

In one embodiment of the disclosure, there is provided a system comprising an operating system, a virtual machine, and an abstraction layer that provides a compatibility interface between the operating system and the virtual machine. The virtual machine is configured to define a first root application context for a first application and at least one further application context for at least one further application. The virtual machine processes operating system resource requests from at least one further application context to the operating system via the root application context.

In one embodiment of the disclosure, there is provided a computer-readable medium comprising computer-executable instructions for execution by a processor, that, when executed receive an operating system resource request from an application context, perform a determination whether an application associated with the application context is allowed to access an operating system resource specified by the operating system resource request, and provide the operating system resource request to an operating system dependent on said determination.

### BRIEF DESCRIPTION OF THE DRAWINGS

The invention will now be described, by way of example only, with reference to specific embodiments and to the accompanying drawings in which :

FIG. 1 illustrates a system for providing an interaction between an application and an operating system;

FIG. 2 illustrates a method for providing the interaction in accordance with an embodiment of the disclosure;

FIG. 3 illustrates a processor and memory of a virtual machine;

FIG. 4 illustrates an instruction set that may be executed using the processor and memory of FIG. 3; and

FIG. 5 illustrates the processor and memory of FIG. 3 in association with a processor and memory of an operating system.

### DETAILED DESCRIPTION OF THE INVENTION

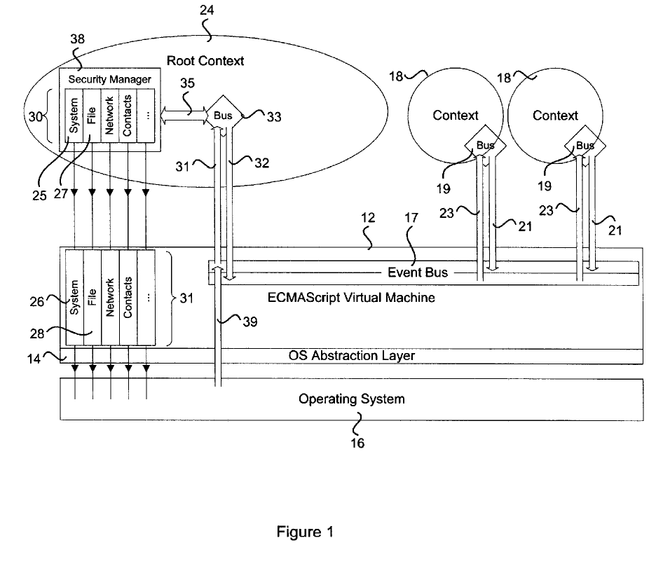

A system 10 in accordance with an embodiment of the disclosure is depicted in FIG. 1. In the system 10, a Virtual Machine 12 is implemented as an Operating System (OS) specific application by adapting a portable runtime to the operating system 16 by means of an abstraction layer 14. The abstraction layer 14 provides a compatibility interface to the operating system 16 that enables the majority of the virtual machine runtime to remain unchanged across different operating systems.

The Virtual Machine 12 enables secure multi-tasking by enabling a unique execution “context” 18 for each set of scripts, i.e. each application. Each context 18 is wholly separate from another and no reference or communication can normally be made from a context to anything else.

The Virtual Machine 12 is designed to provide one native method on each context 18 (that is, make the native method callable from script code), termed native_registerService( ) herein. Each context 18 is completely isolated from the underlying native runtime except for this one access point. This access point is used to bind the context's local (scripted) “event bus” object 19 to the virtual machine's context event bus 17. Each context's EventBus 19 has two methods, postEvent( ) 21 for posting events to the system bus and receiveEvent( ) 23 for receiving events from the system bus.

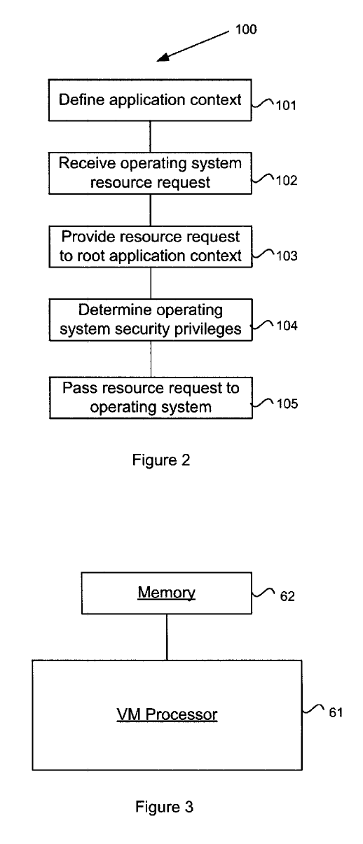

Each script context 18 forwards its native resource requests in the form of events to a specialized context 24, termed the Root Context herein, and that context implements a security check before allowing any interaction with the underlying operating system. Security is achieved on a very fine-grained level in an efficient and easy to maintain manner. FIG. 2 shows a flowchart 100 illustrating a method for providing an interaction between an application executing on the virtual machine 12 and the operating system 16. In the method, an application context 18 of the application is defined at step 101. At step 102, the virtual machine receives an operating system resource request from the application context 18. The operating system resource request is provided to the specialized context, termed the root application context, defined on the virtual machine (step 103). The root application context determines whether the requesting application has operating system privileges for the requested resource (step 104) and if so, provides the operating system resource request to the operating system (step 105).

The root application context is created as the very first context by the Virtual Machine. The root application context is bound with the same native_registerService( ) method as every other context. However, being the root application context enables a scripted object within the Root Context to be bound to additional native service objects 31 in the VM 12. The native service object 31 is an encapsulation of a native operating system feature, such as the System, File, Network, etc., and exposes the native system capabilities of that (OS) feature to the virtual machine 12.

When the operating system launches the Virtual Machine 12 initially, the very first context created is regarded as the Root Context 24, and is given the native_registerService( ) binding upon creation.

Next, each service script in the Root Context 24 is loaded and binds to its native counterpart in the Virtual Machine using the native_registerService( ) call. The binding process passes the service script object 30 in the Root Context 24 to its corresponding counterpart 31 in the VM which then adds additional native methods to the script object—allowing the script object to communicate with its corresponding native system service directly. That is, the script System service 25 of the Root Context 24 binds to the native System service 26 of the Virtual Machine 12, the script File service 27 of the Root Context 24 binds to the native File service 28 of the Virtual Machine 12 etc., as shown in FIG. 1.

At this point, the system is ready to load an application. Each application gets its own Context 18, thus a subsequent Context 18 is created and given the standard native_registerService( ) binding. The virtual machine 12 only allows application contexts to bind to the native EventBus 17. Only the Root Context is allowed by the virtual machine to also bind to native system services 31. All further Context's 18 other than the Root Context 24 have their outbound events on the event bus routed to the receiveEvent( ) function 31 of the event bus object 33 in the Root Context 24. The Root Context 24 is unique in that it is the only context which can direct its outbound events 32 to another specific Context 18.

When an application context 18 wishes to interact with the native system, it will generate a request and send it to the Root Context 24 using the outbound channel 21 of its Event Bus 19. The Root Context 24 will receive the request on the inbound channel 31 of its Event Bus 33 and route it 35 to the appropriate Root Context Service 30, e.g. System 25, File 27, etc.

Each Root Context Service 30 may check with the Security Manager 38 as to whether the request's originating Context has the necessary security privileges to perform the action. It is not possible for an application Context to spoof its identity because the Virtual Machine 12 sets the identity of the requesting Context automatically as it passes the event from the application Context 18 to the Root Context 24.

If the Security Manager 38 indicates that the requesting application has the necessary security privileges, the Root Context Service 30 will interact with its counterpart in the native runtime 31 which will then pass through the OS Abstraction Layer 14 and be processed by the native Operating System 16 Should the Security Manager deny access to the system resource by the application context, the root context service 30 will return a failure response back to the event bus 33 which will then get sent to the application context 18 via the outbound event channel 32.

In the demonstrated embodiment, the Security Manager 38 is implemented as a scripted object within the Root Context 24. The Security Manager encapsulates a repository of permissions information for each of the applications. Permissions information may be stored on the device itself or remotely on a computer network and are loaded by the Security Manager using an appropriate mechanism (such as the filesystem for local access, or via network operations if the information is remote). Alternatively, the Security Manager could be implemented as a native system service 31. The scripted service objects 30 would pass all requests to their native service objects 31, and the native service objects would interact with the Security Manager in the virtual machine 12. This alternative could also allow for the Security Manager 38 to use security functions provided by the Operating System directly if so desired.

Typically, interactions by the virtual machine 12 with the native Operating System 16 are asynchronous. In such cases, the result of the interaction is returned to the Root Context 24 by the system sending an event to the Root Context's event bus, shown as the pipe 39 running from the OS 16 through the Virtual Machine 12 up to the Root Context 24. The Root Context 24 will send the result to the Root Context Service 30 for post-processing (such as cleaning up request tables, freeing resources, etc.) and then send a response event to the originating Application Context 18 using its outbound event channel 32.

An advantage of the above described embodiments includes the relatively simple way in which security of the native operating system can be maintained. Application Contexts are guaranteed to be secure because they have no possibility of interacting with the native system directly since there is no bridge to the native system services 31 and on to the operating system 16. The best that any Application Context can do is to generate and send an event to the Root Context 24 requesting some feature. That event is automatically given an origination id by the native system, guaranteeing that any one Application Context cannot masquerade as another.

The Root Context 24 is the only context with the ability to interact with the native operating system via native services 31, thus there is a single gate at which the request of an application can be matched against its privileges.

The system 10 removes the traditional virtual machine methods of examining a call stack to try to determine the nature of the thread of execution, such as whether the call is from trusted native code or from untrusted application code. Accordingly, the above described embodiments provide a system that is simpler, easier to maintain, and reliably secure.

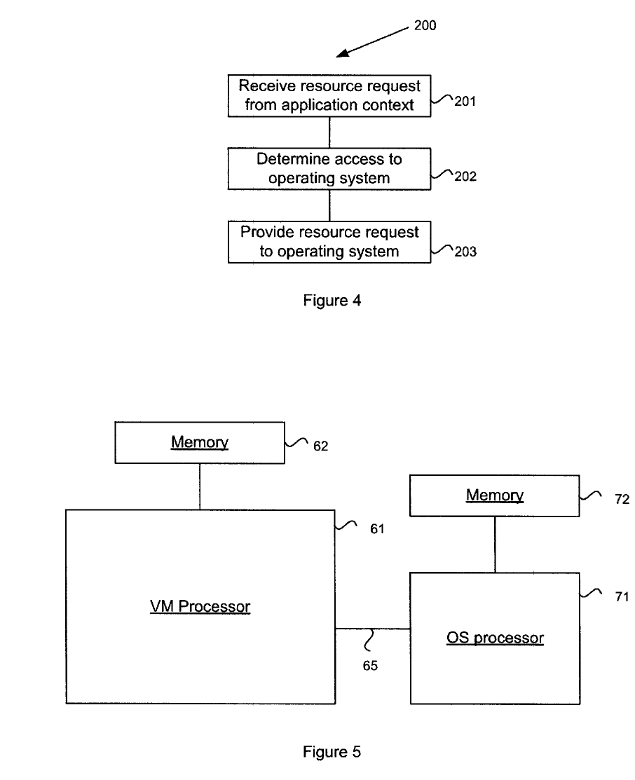

In one embodiment, the virtual machine 12 may include a processor 61 operatively associated with at least one memory 62, as shown in FIG. 3. The memory 62 may store an instruction set that can be executed on the processor 61. An instruction set that may be executed on the processor 61 is shown in FIG. 4 and includes instructions that, when executed, cause the processor to operate the root application context. Specifically, the instructions, when executed, allow the root application context to receive an operating system resource request from an application context (step 201). The root application context will then determine whether an application associated with the application context is allowed to access an operating system resource specified by the operating system resource request (step 202). Depending on the determination, the root application context may then provide the operating system resource request to the operating system (step 203).

In one embodiment, illustrated in FIG. 5, the processor 61 may interface with a second processor 71, such as a processor of the operating system 16. The operating system processor 71 may also have an operatively associated memory 72 and may communicate with the virtual machine processor 71 via a suitable communications link 65. The virtual machine processor 61 may determine whether an application is entitled to request an operating system resource, and if so, pass the resource request to the operating system processor 71 for processing. The operating processor 71 may then pass an operating system response to the virtual machine processor 61 for post processing and downstream processing by the application code of the originating application.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for providing an interaction between an application executing in a virtual machine and an operating system, the method comprising:
defining an application context for the application;
receiving an operating system resource request from the application context;
providing the operating system resource request to a root application context defined in the virtual machine;
determining in the root application context whether the application has operating system privileges for a requested resource; and
providing the operating system resource request to the operating system dependent on the operating system privileges determined for the operating system resource request.

2. The method according to claim 1 wherein defining the application context comprises defining an event bus between the application context and the root application context.

3. The method according to claim 2 wherein the operating system resource request is provided to the root application context as an event on the event bus.

4. The method according to claim 2 wherein defining the application context comprises defining a method for the application context, wherein the method defines a first function for posting events from the application context event bus to an event bus of the virtual machine and a second function for receiving events from the event bus of the virtual machine to the application context event bus.

5. The method according to claim 1 comprising:
defining a plurality of application contexts on the virtual machine;
receiving a plurality of operating system resource requests from the plurality of application contexts; and
routing each operating system resource request to the operating system via the root application context to determine the operating system privileges of the respective operating system resource request.

6. The method according to claim 5 further comprising adding an originating identity to an operating system resource request that identifies the originating application context for the respective operating system resource request.

7. The method according to claim 5 wherein the plurality of further application contexts communicate with the operating system via the root application context only.

8. The method according to claim 1 further comprising defining the root application context on the virtual machine.

9. The method according to claim 8 wherein defining the root application context comprises binding at least one scripted object within the root application context to at least one native object of the virtual machine.

10. The method according to claim 1 comprising returning a response to the operating system resource request to the application context via the root application context.

11. The method according to claim 10 comprising post-processing the response in the root application context.

12. A system comprising:
an operating system;
a virtual machine; and
an abstraction layer that provides a compatibility interface between the operating system and the virtual machine;
wherein the virtual machine is configured to define a first root application context for a first application and at least one further application context for at least one further application; and
wherein the virtual machine provides operating system resource requests from the at least one further application context to the operating system via the root application context.

13. The system according to claim 12 wherein the root application context is configured to determine whether an application has security privileges to access a requested resource of the operating system.

14. The system according to claim 13 wherein the virtual machine defines a security manager in the root application context that determines security privileges for an operating system resource request.

15. The system according to claim 12 comprising an event bus from a said further application context to the root application context via the virtual machine.

16. The system according to claim 15 wherein the at least one further application context provides operating system resource requests as events on the event bus.

17. The system according to claim 15 wherein the virtual machine is configured to add an originating identity to an operating system resource request that identifies to the root application context a further application context that originated an operating system resource request.

18. The system according to claim 12 wherein the virtual machine is configured to bind a scripted object of the root application context to an equivalent native object of the operating system via the virtual machine.

19. A computer-readable medium comprising computer-executable instructions for execution by a processor, that, when executed:
receive an operating system resource request from an application context;
perform a determination whether an application associated with the application context is allowed to access an operating system resource specified by the operating system resource request; and
provide the operating system resource request to an operating system dependent on said determination.

20. The computer-readable medium according to claim 19 further comprising instructions that, when executed, receive a response from the operating system and pass the response to the application context.
